(19) United States
(12) Patent Application Publication
(10) Pub. No.: US 2004/0198598 A1
(43) Pub. Date: Oct. 7, 2004

(54) Porous ceramic material and process for producing the same

(75) Inventors: Tetsuo Kawano, Shizuoka (JP); Hiroaki Imai, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/801,639

(22) Filed: Mar. 17, 2004

(30) Foreign Application Priority Data
Mar. 18, 2003 (JP) 2003-074325

(51) Int. Cl. B01J 23/00

(52) U.S. Cl. 502/349; 502/350; 502/352; 502/354

(57) ABSTRACT

A porous ceramic material has mesopores with a diameter of 2 nm to 50 nm on its surface and is fibrous for the purpose of providing a porous ceramic material which has a very large specific surface area, is fibrous, is flexible and is very useful as catalysts, catalyst carriers, photocatalysts, sensors and oxide conductors. The porous ceramic material can be prepared by immersing the fibrous matrix in an aqueous solution containing a metal source, a surfactant and urea and heating the resulting mixture to thereby deposit a metallic compound on the outer surface of a fibrous matrix; and eliminating the fibrous matrix.

### BACKGROUND OF THE INVENTION

1. Field of the Invention

The present invention relates to a porous ceramic material which is useful as, for example, catalysts, catalyst carriers, photocatalysts, sensors and oxide conductors, and to a process for producing the same.

2. Description of the Related Art

Ceramics have outstanding heat resistance, wear resistance and chemical resistance and are widely used in various functional applications such as photocatalysts and other catalysts, catalyst carriers, and sensors. In these applications, the ceramics are used in the form of a film, or a powder having a large specific surface area and have an insufficient degree of freedom in their shapes. In addition, the ceramics are generally fragile and have insufficient workability.

In applications requiring flexibility, ceramic fibers such as silica fibers, glass fibers, silicon carbide fibers, boron fibers and alumina fibers have been used.

To apply these functional ceramics to catalyst carriers, photocatalysts and other catalysts, and sensors efficiently, the degree of freedom in their shapes must be increased. As a possible solution to this, Japanese Patent Application Laid-Open (JP-A) No. 07-187846 and No. 08-34680 disclose methods for producing a flexible ceramic structure having a complicated fine skeleton, in which a matrix comprising a natural or synthetic porous polymer is impregnated with a solution of a metal alkoxide, the matrix impregnated with the metal alkoxide solution is fired to thereby eliminate the matrix. However, according to these methods, such micropores cannot be significantly impregnated with the alkoxide, and a desired shape is not obtained due to shrinkage in firing.

Another possible solution is forming a thin film of ceramic such as titanium oxide on a matrix by, for example, chemical vapor deposition (CVD), ion plating, sputtering or sol-gel method as disclosed in JP-A No. 09-276705 and No. 11-349326. These techniques are, however, performed at high temperatures and are not suitable for forming a uniform film on the outer surface of fibers such as organic fibers.

Thus, ceramic materials have an insufficient specific surface area in the form of a thin film and have poor handleability in the form of a powder. Ceramic fibers are generally prepared by melting a material and spinning the melted material into fibers, are thereby of high cost and cannot be significantly applied to materials having a high melting point. Alternatively, ceramic fibers are processed into a felt to prepare a fibrous article having a complicated structure. However, this technique requires a large number of processes such as spinning, cutting and molding, thus leading to high cost.

These conventional techniques have failed to provide a porous ceramic material efficiently at low cost, and strong demands have been made on such a technology to solve these problems.

Objects and Advantages

Accordingly, an object of the present invention is to provide a porous ceramic material which is useful as, for example, photocatalysts and other catalysts, catalyst carriers, sensors and oxide conductors. Another object of the present invention is to provide a method for efficiently producing the porous ceramic material at low cost.

### SUMMARY OF THE INVENTION

Specifically, the present invention provides a porous ceramic material having mesopores with a diameter of 2 nm to 50 nm on its surface and being fibrous. The porous ceramic material has a very large specific surface area, is fibrous, thereby has flexibility and is very useful as catalysts, photocatalysts, catalyst carriers, sensors and oxide conductors.

The present invention also provides a process for producing a porous ceramic material, including the steps of immersing a fibrous matrix in an aqueous solution containing a metal source, a surfactant and urea, and heating the aqueous solution so as to deposit a metallic compound on the outer surface of the fibrous matrix; and eliminating the fibrous matrix from the resulted fibrous matrix bearing the deposited metallic compound on the outer surface thereof. The process can efficiently produce a fibrous porous ceramic material having mesopores with a diameter of 2 nm to 50 nm on its surface at low cost.

### BRIEF DESCRIPTION OF THE DRAWINGS

FIGS. 1A, 1B and 1C are each a schematic diagram showing the relationship between pH and the crystal structure of a metal oxide and a surfactant;

FIG. 2 is a schematic diagram showing an example of a process for producing a porous ceramic material of the present invention;

FIG. 3 is a scanning electron micrograph (SEM) of the aluminum hydroxide film prepared in Example 1;

FIG. 4 is an enlarged view of FIG. 3;

FIG. 5 is a further enlarged view of FIG. 4;

FIG. 6 is a scanning electron micrograph (SEM) of the aluminum oxide material prepared in Example 1;

FIG. 7 is an enlarged view of FIG. 6;

FIG. 8 is a further enlarged view of FIG. 7;

FIG. 9 is a transmission electron micrograph (TEM) of the aluminum oxide material prepared in Example 1;

FIG. 10 is an enlarged view of FIG. 9; and

FIG. 11 is a scanning electron micrograph (SEM) of the aluminum hydroxide film prepared in Comparative Example 1.

### DESCRIPTION OF THE PREFERRED EMBODIMENTS

Porous Ceramic Material

The porous ceramic material of the present invention has mesopores with a diameter of 2 nm to 50 nm and has a fibrous (in the form of a fiber).

The diameter of the mesopores should be from 2 nm to 50 nm and is preferably from 2 nm to 10 nm. According to the definition by International Union of Pure and Applied Chemistry (IUPAC), porous substances are classified as microporous substances having pores with a diameter of 2 nm or less, mesoporous substances having pores with a diameter of 2 nm to 50 nm, and macroporous substances having pores with a diameter of 50 nm or more. The porous ceramic material of the present invention is therefore a “mesoporous ceramic fiber” which has mesopores and is fibrous.

The diameter and distribution of pores in the porous ceramic material can be determined, for example, by transmission electron microscopy (TEM), X-ray diffractometry (XRD) or nitrogen adsorption measuring technique according to the Brunauer-Emmett-Teller (BET) method.

The porous ceramic material preferably has a substantially hollow or substantially solid fibrous structure. Such a hollow porous ceramic material is preferable from the viewpoints that the hollow porous ceramic material has, not only the outer surface, but also the interior surface which can allow the skeleton of fiber to be exposed to the atmosphere, and thereby has a significantly increased specific surface area. The aforementioned “substantially solid fibrous structure” means and includes a fully solid structure, a structure having a partially broken or clogged hollow portion, and a structure having a discontinuous hollow portion.

The mesopores in the porous ceramic material preferably has a crystal structure including a hexagonal structure.

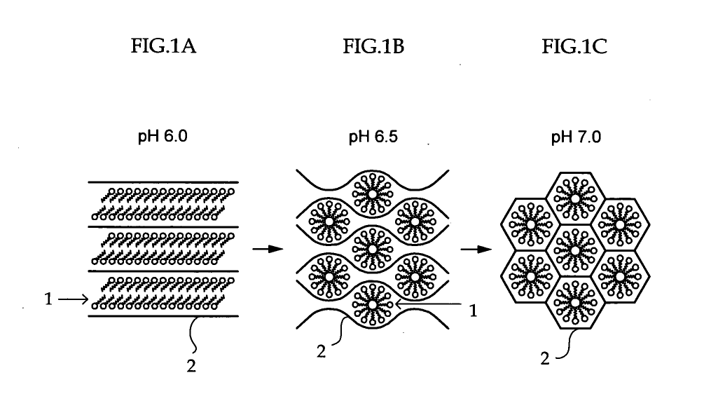

More specifically, the porous ceramic material, such as a mesoporous metal oxide, can form its crystal structure by using a micelle formed from a surfactant in an aqueous solution as a template, as shown in FIGS. 1A, 1B and 1C. For example, a surfactant 1 having a hydrophilic group and a hydrophobic group, such as a sodium dodecyl sulfate (SDS), and a metal oxide 2 such as aluminum oxide form the following structures in an aqueous solution. At pH 6.0, they form a lamella structure in which the hydrophobic groups are concentrated at the center of micelle and the hydrophilic groups are positioned on the outer surface thereof (FIG. 1A). At pH 6.5, they form a structure as a mixture of a lamella structure and a hexagonal structure (FIG. 1B). At pH 7.0, they form a micelle having a liquid crystalline structure having a hexagonal profile extending in the longitudinal direction (FIG. 1C).

The surfactant constituting a micelle can have gaps or space which solute molecules can come into and go out. By dissolving a precursor of the metal oxide in a medium, the precursor can come into the gaps. The precursor of metal oxide positioned in the gaps is then insolubilized by, for example, hydrolysis to yield a metallic compound with a shape transcript from the micelle as a template. The metallic compound is then fired or burnt according to necessity and thereby yields a mesoporous metal oxide having a crystal structure including a hexagonal structure.

The crystal structure of the porous ceramic material can be determined, for example, by scanning electron microscopy (SEM), X-ray diffractometry (XRD) or transmission electron microscopy (TEM).

The ceramic material is not specifically limited, can be selected according to the purpose and includes, for example, alumina, titania, tin oxides, zirconia, silica, or mixtures thereof. Among them, alumina, titania, tin oxide and silica are preferred, of which a fibrous porous aluminum oxide having mesopores with a diameter of 2 nm to 10 nm is typically preferred.

The porous ceramic material of the present invention is elastic and can return to its original shape even when slightly pressed by the hand. The porous ceramic material can be converted into a paste of short fibers by crushing or grinding. By applying the paste to a carrier, it can be used as a catalyst.

When the porous ceramic material comprises tin oxide, it has a larger contact area and exhibits a higher electric conductivity than a powdery tin oxide having the same weight when used as a component in a conductive paint.

When the porous ceramic material comprises titania, it can work as a photocatalyst with higher efficiency and is useful as a decomposition catalyst for dioxins and NOx (nitrogen oxides).

When the porous ceramic material comprises silica, it is useful as a catalyst carrier having a high specific surface area and a low pressure loss.

When the porous ceramic material comprises alumina, it is useful as an alumina catalyst or catalyst carrier having a high specific surface area and a low pressure loss.

Process for Producing Porous Ceramic Material

The process for producing a porous ceramic material of the present invention comprises a depositing a metallic compound step and a eliminating a fibrous matrix step and may further comprise one or more other steps.

This process produces a porous ceramic material having a substantially hollow or substantially solid fibrous structure as a skeleton. The porous ceramic material has pores corresponding to the shape of the fibrous matrix as a template. The porous ceramic material has mesopores with a diameter of 2 nm to 50 nm on its outer surface and has a significantly increased specific surface area, since the mesopores provide a surface communicating to the outer atmosphere inside the skeleton of the ceramic.

Metallic Compound Depositing Step

The metallic compound depositing step is a process of immersing a fibrous matrix in an aqueous solution containing a metal source, a surfactant and urea, and heating the aqueous solution so as to deposit a metallic compound on the outer surface of the fibrous matrix.

This process is generally referred to as “chemical solution deposition” and utilizes deposition from an aqueous solution, for example, by hydrolysis. The fibrous matrix such as cotton, wool or another naturally organic fiber or a synthetic fiber preferably has a hydrophilic surface. If the fibrous matrix as intact does not have hydrophilicity, it may be hydrophilized according to a conventional procedure.

The fibrous matrix is not specifically limited, can be selected according to the purpose, as long as it can be eliminated by firing, and includes, for example, cotton fibers, wool fibers and synthetic fibers. Among them, cotton fibers are preferred for their easy elimination.

The metal source is not specifically limited, can be selected according to the purpose and includes, for example, Al halide, Al alkoxide, Al sulfate, Al oxysulfate, Al nitrate, Al acetate, Al oxalate, aluminate, Ti halide, Ti alkoxide, Ti sulfate, Ti oxysulfate, Ti nitrate, Ti acetate, Ti oxalate, titanate, Sn halide, Sn alkoxide, Sn sulfate, Sn oxysulfate, Sn nitrate, Sn acetate, Sn oxalate, stannate, Si halide, Si alkoxide, Si sulfate, Si oxysulfate, Si nitrate, Si acetate, Si oxalate, silicate, Zr halide, Zr alkoxide, Zr sulfate, Zr oxysulfate, Zr nitrate, Zr acetate, Zr oxalate, Zn halides, Zn alkoxides, Zn sulfate, Zn oxysulfate, Zn nitrate, Zn acetate, Zn oxalate, and hydrates thereof. Each of these can be used alone or in combination. Among them, Al(NO₃)₃, AlCl₃ and hydrates thereof are preferred.

The surfactant is not specifically limited and can be selected according to the purpose. Among such surfactants, anionic surfactants containing a dodecyl sulfate ion are preferred, of which sodium dodecyl sulfate (SDS) is typically preferred.

The aqueous solution for use herein preferably comprises 1 part by mol to 10 parts by mole of the surfactant, 10 parts by mol to 50 parts by mole of urea and 1 part by mol to 100 parts by mole of water with respect to 1 part by mole of the metal source. More preferably, it comprises 1 part by mol to 4 parts by mole of the surfactant, 10 parts by mol to 40 parts by mole of urea and 10 parts by mol to 100 parts by mole of water with respect to 1 part by mole of the metal source.

These proportions are advantageous for forming a micelle and for forming a uniform solution.

The fibrous matrix is preferably immersed in the aqueous solution containing the metal source, surfactant and urea, at the temperature of 60° C. to 90° C. The urea in the aqueous solution is decomposed according to the formula: (NH₂)₂CO→3H₂O→2NH₄⁺+2OH⁻+CO₂ at a temperature of 60° C. or higher. The aqueous solution thereby gradually becomes basic which is advantageous for the formation of a hexagonal structure. More specifically, the fibrous matrix is preferably immersed in the aqueous solution heated at 60° C. to 90° C. until it has pH of 6 to 8. The immersion time is not specifically limited, can be set depending on the purpose and is preferably 1 hour or longer, and more preferably 1 hour to 24 hours.

The porous ceramic material is prepared by depositing a metallic compound on the outer surface of the fibrous matrix. If a film of the metal oxide to be formed on the fibrous matrix has a thickness less than about 0.1 μm, the film shrinks and thereby deforms its shape in firing for eliminating the fibrous matrix. When the film comprises titanium oxide and the porous ceramic material is used as a catalyst, the thickness of the film is preferably from about 1 μm to about 2 μm. The thickness increases proportionally to an increasing immersion time.

The fibrous matrix covered with the deposited metallic compound before the elimination of the fibrous matrix in the subsequent process also has mesopores on its surface and thereby has a sufficiently large specific surface area. This article, e.g., a fabric covered with aluminum hydroxide, can be used as a satisfactory recording medium in ink-jet recording.

Fibrous Matrix Eliminating Process

The fibrous matrix eliminating step is a step of eliminating the fibrous matrix from the resulted fibrous matrix bearing the deposited metallic compound on the outer surface thereof.

The fibrous matrix can be eliminated by any procedure according to the purpose. It is preferred that the fibrous matrix eliminating step comprises a step of firing the fibrous matrix so as to burn out the fibrous matrix.

More specifically, the fibrous matrix bearing the metal oxide deposited thereon is taken out from the aqueous solution, is dried and is fired at 500° C. to 1,300° C. for preferably 60 minutes or longer and more preferably 180 minutes or longer to thereby eliminate (burn out) the fibrous matrix. In this procedure, the film of metal oxide on the outer surface of the fibrous matrix does not break or expand, and the fibrous matrix is gasified and escapes from mesopores of the metallic compound film or tips of the fibrous matrix not covered with the metal oxide.

Alternatively, instead of firing, the fibrous matrix may be eliminated by immersing the fibrous matrix bearing the metal oxide film deposited thereon in a medium that can dissolve the fibrous matrix in a short time, such as a basic solution or an organic solvent, to thereby dissolve and eliminate the fibrous matrix.

As a result of elimination of the fibrous matrix, a hollow portion on the order of micrometers communicating the outer atmosphere is formed in a short time inside the resulting ceramic fiber. The shape of the hollow portion corresponds to the shape of the fibrous matrix. The inside surface of the continuous or discontinuous hollow portion is a transcription of the outer surface of the fibrous matrix. If the fibrous matrix has a rough surface, the hollow portion has a rough inner surface. Vise vista, if the fibrous matrix has a smooth surface, the hollow portion has a smooth inner surface. Thus, the roughness of the inner surface of the continuous or discontinuous hollow portion can be arbitrarily controlled.

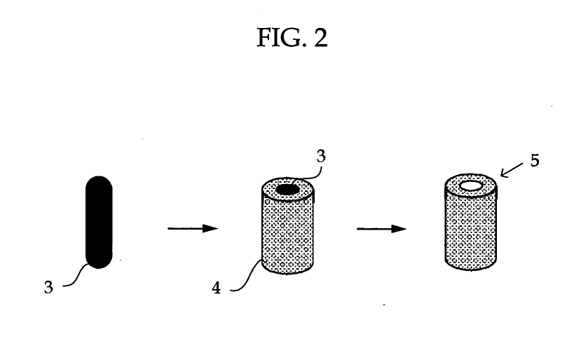

A specific example of the process for producing a porous ceramic material of the present invention is illustrated in FIG. 2. In this example, a cotton fiber 3 is immersed in an aqueous solution containing 1 part by mole of at least one of Al(NO₃)₃ hydrates and AlCl₃ hydrates as the metal source, 2 parts by mole of sodium dodecyl sulfate (SDS), 10 to 40 parts by mole of urea, and 60 parts by mole of water at 60° C. to 90° C. The cotton fiber 3 bearing a film of aluminium hydroxide 4 on its outer surface is then fired to eliminate the cotton fiber, to yield a substantially hollow or solid fibrous porous aluminium oxide material. In FIG. 2, a hollow aluminum oxide material 5 is illustrated.

According to the method of the present invention, a porous ceramic material in the form of, for example, felt, lace or staple can be prepared directly from a material, without a process of spinning the material into fibers.

By using an aqueous solution containing a metal halide, a film of metal oxide such as titanium oxide can be prepared at a relatively low temperature from room temperature to about 70° C. Accordingly, a metal oxide film having a desired thickness can be efficiently formed at low cost only by immersing the fibrous matrix in the aqueous solution and leaving it for a predetermined time. Preferred examples of the metal halide for use in the deposition of the metal oxide from the aqueous solution at a relatively low temperature are TiF₄, SnF₂ and SiF₆. The hydrolysis reaction in the aqueous solution is represented by the following formulae.

In the case of TiF₄:

TiF₄+H₂O→Ti(OH)₄→TiO₂

In the case of SnF₂:

SnF₂+H₂O+O₂→Sn(OH)₄→SnO₂

By adding SbF₃ in the formation of SnO₂ using SnF₂, a substantially hollow or substantially solid fiber of Sb-doped SnO₂ can be prepared.

If titanium oxide formed by chemical solution deposition contains a small proportion of anatase titanium oxide, the reaction system may be heated at about 300° C. to about 500° C. to increase the proportion of anatase titanium oxide. Separately, a reaction system containing stannic oxide may be heated at about 250° C. to about 1,500° C. to increase the crystallinity of stannic oxide. The fibrous matrix can also be eliminated by such a heat treatment.

The present invention will be illustrated in further detail with reference to an example and several comparative examples below, which are not intended to limit the scope of the present invention.

### EXAMPLE 1

Metallic Compound Depositing Step

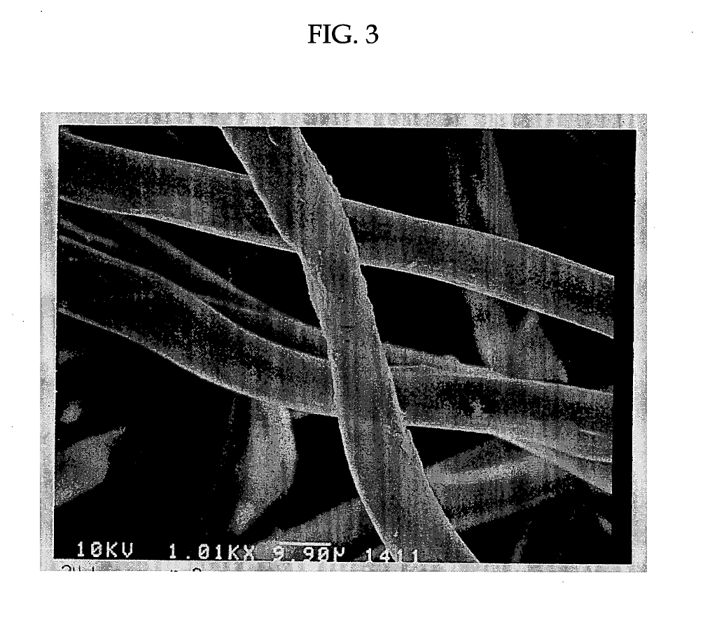

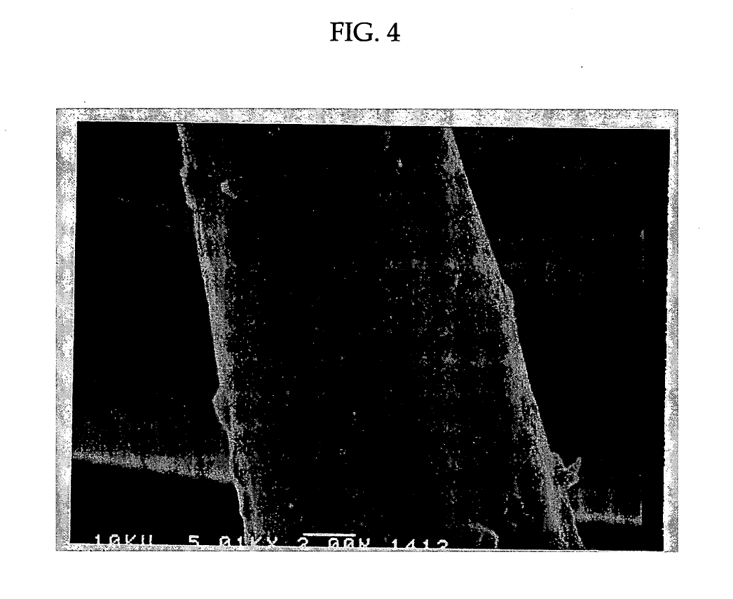

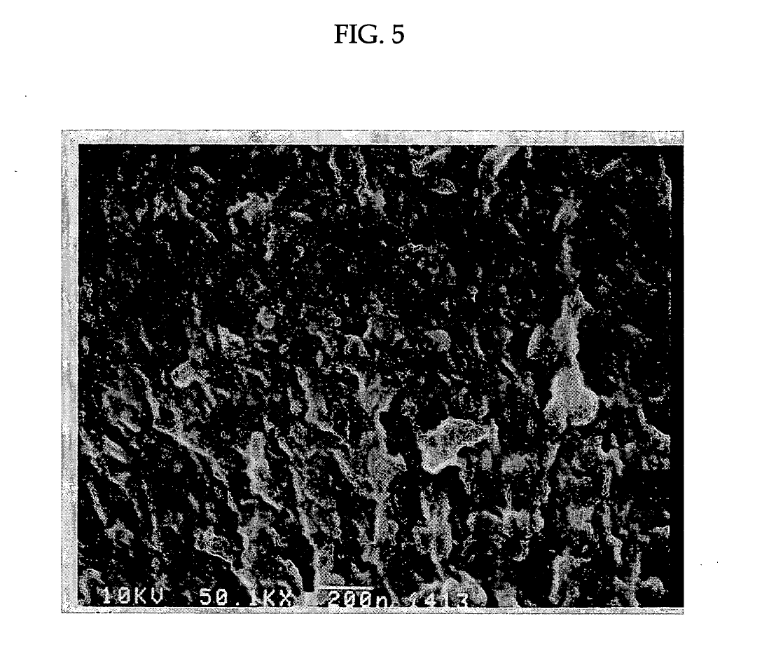

An aqueous solution pH 3.65 was prepared by stirring 1 part by mole of Al(NO₃)₃.9H₂O, 2 parts by mole of sodium dodecyl sulfate (SDS), 20 parts by mole of urea and 60 parts by mole of water for one hour. A cotton fiber was immersed in the aqueous solution at 70° C. for 24 hours to thereby deposit a film of aluminum hydroxide on the outer surface of the cotton fiber. The aqueous solution after the completion of reaction had pH of 7.0. Scanning electron micrographs of the resulting aluminum hydroxide film are shown in FIGS. 3 to 5, in which FIG. 4 is an enlarged view of FIG. 3, and FIG. 5 is a further enlarged view of FIG. 4.

Fibrous Matrix Eliminating Step

The composite article bearing the deposited aluminum hydroxide film was fired at 600° C. in an air atmosphere for minutes to thereby eliminate (burn out) the cotton fiber, to yield an aluminum oxide material.

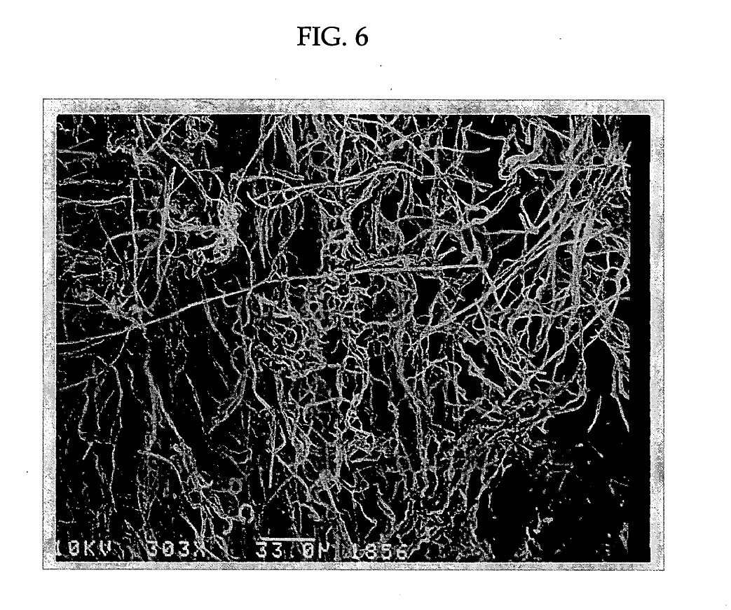

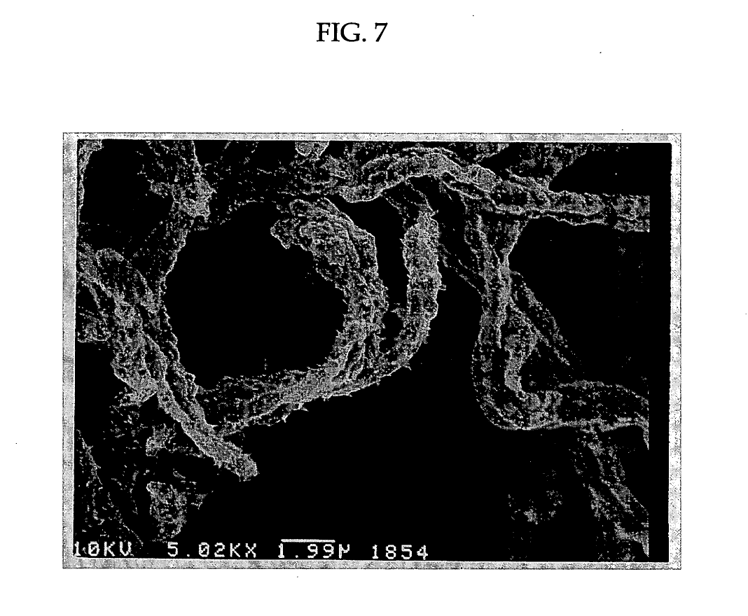

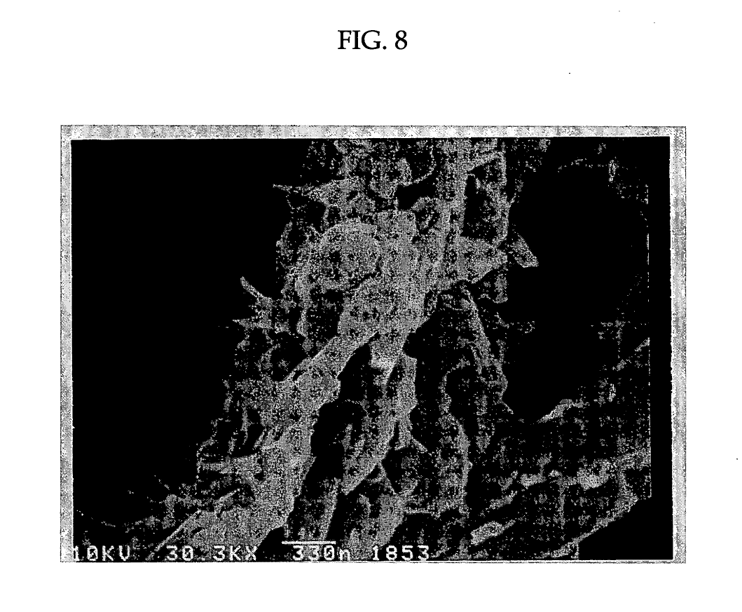

Scanning electron micrographs (SEM) of the aluminum oxide material are shown in FIGS. 6 to 8, in which FIG. 7 is an enlarged view of FIG. 6, and FIG. 8 is a further enlarged view of FIG. 7.

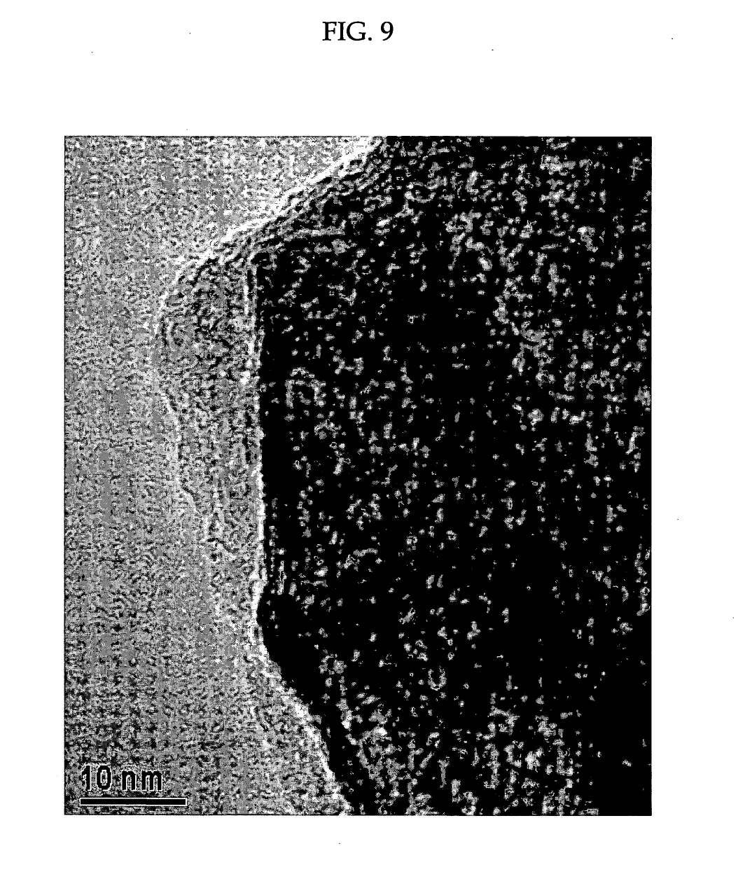

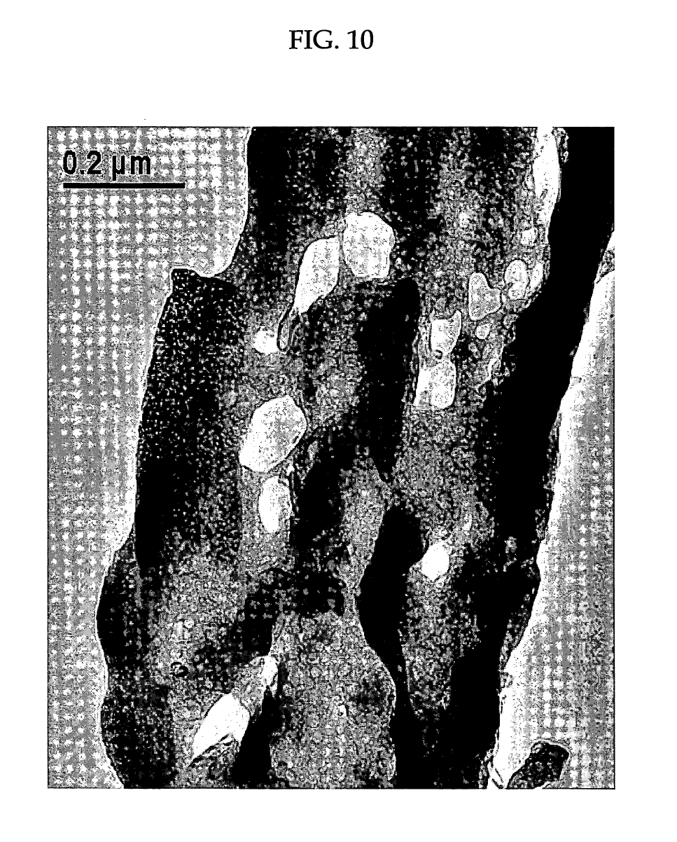

Transmission electron micrographs (TEM) of the aluminum oxide material are shown in FIGS. 9 and 10, in which FIG. 10 is an enlarged view of FIG. 9.

These results show that the aluminum oxide material is a substantially solid fiber having an outer diameter of 0.3 μm to 1.2 μm and has pores on its surface. The transmission electron micrographs (TEM) show that these pores are mesopores with a diameter of 2 nm to 10 nm.

The aluminum oxide material was elastic and returned to its original shape even when slightly pressed by the hand.

### COMPARATIVE EXAMPLE 1

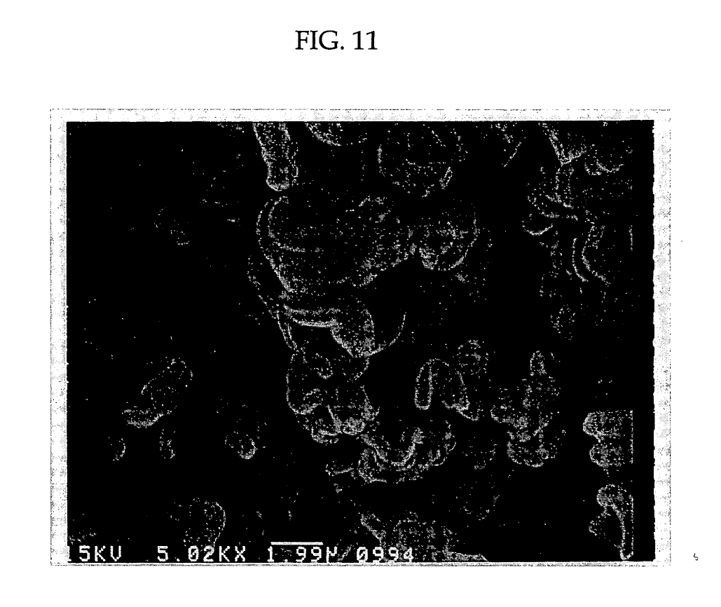

The procedure of Example 1 was repeated, except using a glass substrate instead of the cotton fiber. Specifically, the glass substrate was immersed in the aqueous solution at 70° C. for 24 hours. A scanning electron micrograph (SEM) of the resulting aluminium hydroxide film is shown in FIG. 11, indicating that the film had pores on its surface.

The glass substrate bearing the deposited aluminum hydroxide film was dried and was fired at 600° C. in an air atmosphere for 180 minutes. The resulting aluminum oxide material was not in the form of a fiber but in the form of a thin film.

### COMPARATIVE EXAMPLE 2

The procedure of Example 1 was repeated except that SDS was not added to the aqueous solution. Specifically, the cotton fiber was immersed in the aqueous solution at 70° C. for 24 hours.

As a result, a film of aluminum hydroxide was not deposited on the cotton fiber. The resulting article was dried and was fired at 600° C. in an air atmosphere for 180 minutes, but nothing remained.

The present invention can efficiently produce a porous ceramic material at low cost. The resulting porous ceramic material has a very large specific surface area, is fibrous, is flexible and is very useful as photocatalysts and other catalysts, catalyst carriers, sensors and oxide conductors.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A porous ceramic material having mesopores with a diameter of 2 nm to 50 nm on the surface thereof and being fibrous.

2. A porous ceramic material according to claim 1, which is a substantially hollow fiber or a substantially solid fiber.

3. A porous ceramic material according to claim 1, wherein the mesopores have a pore structure including a hexagonal structure.

4. A porous ceramic material according to claim 1, wherein the porous ceramic material comprises at least one selected from the group consisting of alumina, titania, tin oxide, zirconia, zinc oxide and silica.

5. A porous ceramic material according to claim 4, wherein the porous ceramic material comprises one selected from the group consisting of alumina, titania and tin oxide.

6. A porous ceramic material according to claim 1, which is a fibrous porous aluminum oxide having mesopores with a diameter of 2 nm to 10 nm.

7. A porous ceramic material according to claim 1, which is at least one selected from the group consisting of a catalyst, a catalyst carrier, a photocatalyst, a sensor and an oxide conductor.

8. A process for producing a porous ceramic material, comprising the steps of:
immersing a fibrous matrix in an aqueous solution containing a metal source, a surfactant and urea, and heating the aqueous solution so as to deposit a metallic compound on the outer surface of the fibrous matrix; and
eliminating the fibrous matrix from the resulted fibrous matrix bearing the deposited metallic compound on the outer surface thereof.

9. A process for producing a porous ceramic material according to claim 8, wherein the step of eliminating the fibrous matrix comprises firing the fibrous matrix bearing the deposited metallic compound so as to burn out the fibrous matrix.

10. A process for producing a porous ceramic material according to claim 9, wherein firing is conducted at 500° C. to 1,300° C. for 60 minutes or longer.

11. A process for producing a porous ceramic material according to claim 8, wherein the fibrous matrix is at least one selected from the group consisting of a cotton fiber, a wool fiber and a synthetic fiber.

12. A process for producing a porous ceramic material according to claim 11, wherein the fibrous matrix is a cotton fiber.

13. A process for producing a porous ceramic material according to claim 8, wherein the metal source is at least one selected from the group consisting of Al halide, Al alkoxide, Al sulfate, Al oxysulfate, Al nitrate, Al acetate, Al oxalate, aluminate, Ti halide, Ti alkoxide, Ti sulfate, Ti oxysulfate, Ti nitrate, Ti acetate, Ti oxalate, titanate, Sn halide, Sn alkoxide, Sn sulfate, Sn oxysulfate, Sn nitrate, Sn acetate, Sn oxalate, stannate, Si halide, Si alkoxide, Si sulfate, Si oxysulfate, Si nitrate, Si acetate, Si oxalate, silicate, Zr halide, Zr alkoxide, Zr sulfate, Zr oxysulfate, Zr nitrate, Zr acetate, Zr oxalate, Zn halide, Zn alkoxide, Zn sulfate, Zn oxysulfate, Zn nitrate, Zn acetate, Zn oxalate, and hydrates thereof.

14. A process for producing a porous ceramic material according to claim 13, wherein the metal source is at least one of Al(NO₃)₃, AlCl₃, and hydrates thereof.

15. A process for producing a porous ceramic material according to claim 8, wherein the surfactant is an anionic surfactant containing a dodecyl sulfate ion.

16. A process for producing a porous ceramic material according to claim 15, wherein the surfactant is sodium dodecyl sulfate.

17. A process for producing a porous ceramic material according to claim 8, wherein the aqueous solution contains 1 part by mole to 10 parts by mole of the surfactant, 10 parts by mole to 50 parts by mole of urea and 1 part by mole to 100 parts by mole of water with respect to 1 part by mole of the metal source.

18. A process for producing a porous ceramic material according to claim 8, wherein the immersing of the fibrous matrix in the aqueous solution is conducted at the aqueous solution temperature of 60° C. to 90° C. for 1 hour or longer.
